(19) United States
(12) Patent Application Publication
(10) Pub. No.: US 2026/0276306 A1
(43) Pub. Date: Sep. 17, 2026

(54) FEEDING AND DISCHARGING APPARATUS AND ANNEALING FURNACE USING SUCH APPARATUS

(71) Applicant: NINGBO SACHSEN INDUSTRIAL TECHNOLOGY CO.,LTD., Ningbo (CN)

(72) Inventor: Wanglin ZHENG, Ningbo (CN)

(73) Assignee: NINGBO SACHSEN INDUSTRIAL TECHNOLOGY CO.,LTD., Ningbo (CN)

(21) Appl. No.: 19/192,384

(22) Filed: Apr. 29, 2025

(30) Foreign Application Priority Data
Mar. 12, 2025 (CN) 202510285985.5

(51) Int. Cl. F27D 3/00

(52) U.S. Cl. CPC F27D 3/00; F27D 2003/0059

(57) ABSTRACT

A feeding and discharging apparatus and an annealing furnace includes a rack, guiding rails, and a material cart, with the rack and guiding rails both embedded underground, reducing mounting space and facilitating maintenance. A gear meshes with the rack to drive the material cart to operate, avoiding the risk of slipping, with high transmission efficiency and good synchronization. Guiding wheels are arranged on two sides of the material cart, with the guiding wheels rollably abutting against top walls of depressions of the guiding rails, effectively preventing lateral deviation and vertical vibration of the material cart, thus ensuring the precision and stability of the movement trajectory. The guiding wheels are adjusted by an adjustable mechanism to fit different specifications of guiding rails, with a simple structure, convenient operation, and high adjustment precision. The apparatus operates smoothly, has excellent anti-vibration performance and long service life, and is suitable for material conveying equipment.

### CROSS REFERENCE TO RELATED APPLICATION

This application is based upon and claims foreign priority to Chinese Patent Application No. 202510285985.5, filed on Mar. 12, 2025, the entire content of which is incorporated herein by reference.

### TECHNICAL FIELD

This application relates to the field of annealing furnace technologies, specifically to a feeding and discharging apparatus and an annealing furnace using the feeding and discharging apparatus.

### BACKGROUND

In industrial production, equipment such as annealing furnaces often require feeding and discharging apparatuses to transport materials. The existing feeding and discharging apparatuses usually adopt the method of using a traction cart to drive a material cart to move along guiding rails. The traction cart is driven by a driving mechanism to run linearly along the guiding rails, and the traction cart can drive the material cart to move linearly along the guiding rails. However, the prior art has the following shortcomings:
1. The existing traction carts mostly adopt friction drive or chain traction methods, which have the risk of slipping, low transmission efficiency, and difficulty in ensuring the synchronization of the traction cart operation.
2. The existing traction carts are mostly supported on the top surface of the guiding rails only by traveling wheels, lacking effective lateral guiding structures. As a result, the traction cart easily experiences lateral deviation and vertical vibration during operation, affecting the accuracy of the movement trajectory.
3. The traction cart is easily affected by vibration during high-speed operation, leading to an unstable material transport process, and even the risk of material tipping over or falling off.
4. An effective anti-vibration structure is lacking, and the traction cart may experience vertical vibration during operation, affecting operational stability and reducing the service life of the equipment.

Therefore, the prior art urgently needs to provide a feeding and discharging apparatus with high transmission efficiency, stable operation, excellent anti-vibration performance, and long service life to alleviate the above shortcomings.

### SUMMARY

An objective of the present invention is to overcome the deficiencies of the prior art and provide a feeding and discharging apparatus and an annealing furnace using such apparatus, which feature high transmission efficiency, stable operation, good anti-vibration performance, and long service life.

The feeding and discharging apparatus provided by this application includes a rack, two guiding rails, a traction cart, and a material cart.

The rack extends linearly.

The two guiding rails are respectively located on two sides of the rack, the two guiding rails both extend linearly and are parallel to the rack, and side walls of the two guiding rails are each provided with a depression extending along a length direction of the guiding rail.

Two sides of the traction cart are each provided with a traveling wheel and a guiding wheel, the traveling wheels on two sides of the traction cart rollably abut against top surfaces of the two guiding rails, respectively, and the guiding wheels on two sides of the traction cart rollably abut against top walls of the depressions of the two guiding rails, respectively.

The traction cart is provided with a driving gear and a driving mechanism for driving the driving gear to rotate, and the driving gear meshes with the rack, such that the driving gear rotates forward or backward to drive the traction cart to move forward or backward along the rack.

The material cart is movably disposed on the two guiding rails, and the traction cart is configured to drive the material cart to move forward or backward along the guiding rails.

Preferably, the guiding wheels are adjustably disposed on two sides of the traction cart, and the guiding wheels are adjustable in a vertical direction, such that the guiding wheels approach or leave the top walls of the depressions.

Preferably, mounting seats are disposed on two sides of the traction cart, the mounting seat is fixedly provided with a support portion, the mounting seat is vertically provided with a guide hole, a movable plate is movably inserted into the guide hole, an upper end of the movable plate is fixedly provided with a connecting portion, and the connecting portion is located above the support portion, the connecting portion is provided with a threaded through hole, a bolt passes downward through and engages with the threaded through hole, a lower end of the bolt abuts against an upper surface of the support portion, and the guiding wheel is disposed on a lower portion of the movable plate.

Preferably, the upper surface of the support portion is provided with a groove, and the lower end of the bolt abuts against a bottom surface of the groove.

Preferably, the driving mechanism includes a driving motor, a first transmission shaft, and a second transmission shaft, the driving motor is fixedly disposed on an upper side of the traction cart, the first transmission shaft is rotatably disposed on the upper side of the traction cart, a first transmission gear fixedly sleeves the first transmission shaft, the driving motor is configured to drive the first transmission shaft to rotate, the second transmission shaft is rotatably disposed on a lower side of the traction cart, a second transmission gear fixedly sleeves the second transmission shaft, the first transmission gear and the second transmission gear are connected via a chain to rotate synchronously, the traction cart is provided with a through hole for the chain to pass through, and the driving gear fixedly sleeves the second transmission shaft.

Preferably, the rack and the two guiding rails are both embedded underground.

The annealing furnace provided by this application includes the feeding and discharging apparatus.

One or more technical solutions provided in this application have at least the following technical effects or advantages:

The feeding and discharging apparatus of the present invention drives the traction cart to move linearly through the meshing transmission between the gear and the rack, with the guiding wheel structures disposed on two sides of the traction cart to achieve dual guidance in the lateral and vertical directions. Its advantages include: 1. The transmission efficiency is high, and the meshing transmission between the gear and the rack avoids the slippage problem of friction drive and provides direct power transmission, reducing energy loss. 2. The meshing transmission ensures the synchronization of the traction cart's operation, and the traction cart's movement trajectory can be precisely controlled, allowing for a high-precision movement trajectory, thus making the apparatus suitable for long-distance transportation. 3. The guiding wheels fit with the top walls of the depressions on the guiding rails, forming a dual guidance structure, which effectively prevents lateral deviation of the traction cart and improves the operational stability. 4. The guiding wheels not only prevent lateral deviation but also effectively restrict vertical vibration of the traction cart, significantly improving anti-vibration performance and ensuring smooth and reliable material transportation. 5. The adjustable structure design of the guiding wheels can adapt to different specifications of guiding rails, further improving the guiding effect and prolonging the equipment's service life. 6. The overall structure is simple, easy to mount and maintain, highly reliable, and suitable for long-term continuous operation.

### BRIEF DESCRIPTION OF THE DRAWINGS

FIG. 1 is a schematic structural diagram of a feeding and discharging apparatus according to an embodiment.

FIG. 2 is a sectional view of the feeding and discharging apparatus according to an embodiment.

FIG. 3 is a schematic structural diagram of cooperation between a side of a traction cart and a guiding rail.

FIG. 4 is a schematic structural diagram of an annealing furnace according to an embodiment.

Reference numerals in the drawings: 10. rack; 20. guiding rail; 21. depression; 30. traction cart; 31. traveling wheel; 32. guiding wheel; 33. driving gear; 34. mounting seat; 341. support portion; 3411. groove; 342. guide hole; 35. movable plate; 351. connecting portion; 3511. threaded through hole; 352. mounting column; 36. bolt; 37. through hole; 40. driving motor; 50. first transmission shaft; 51. first transmission gear; 60. second transmission shaft; 61. second transmission gear; 70. chain; 80. ground; 81. groove; 90. material cart; and 100. furnace body.

### DETAILED DESCRIPTION OF THE EMBODIMENTS

To make the above objectives, features, and advantages of the present invention more apparent and understandable, the following describes specific embodiments of the present invention in detail with reference to the accompanying drawings.

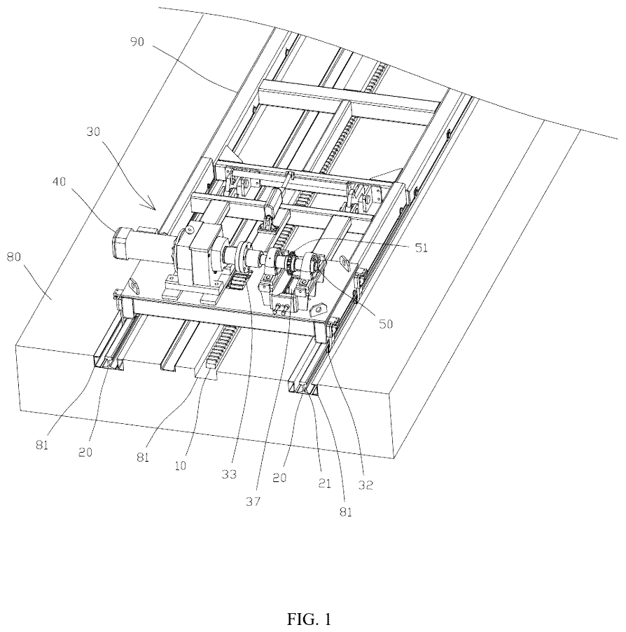

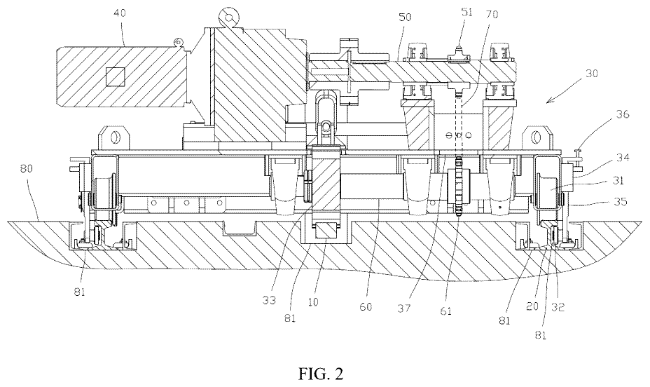

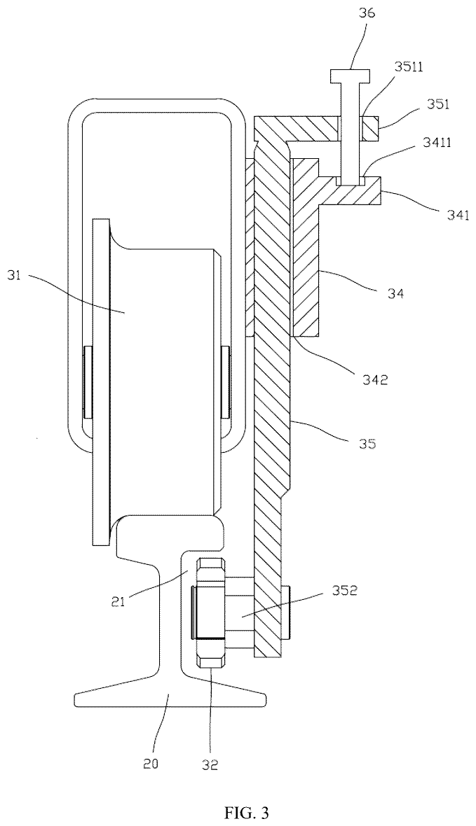

As shown in FIGS. 1 to 3, a feeding and discharging apparatus of an embodiment includes a rack 10, two guiding rails 20, a traction cart 30, and a material cart 90.

Three grooves 81 are provided on the ground 80, the three grooves 81 all extend linearly and are parallel to each other, the rack 10 extends linearly, the two guiding rails 20 are respectively located on two sides of the rack 10, the two guiding rails 20 extend linearly and are parallel to the rack 10, the rack 10 and the two guiding rails 20 are respectively mounted in the three grooves 81, and the upper end surfaces of the rack 10 and the two guiding rails 20 are approximately flush with the ground 80. In other words, the rack 10 and the two guiding rails 20 are all embedded underground, reducing the mounting space for the feeding and discharging apparatus and preventing the rack 10 and guiding rails 20 from obstructing the passage of other vehicles (for example, forklifts).

Side walls of the two guiding rails 20 are each provided with a depression 21 extending along a length direction of the guiding rail 20.

Two sides of the traction cart 30 are each provided with a traveling wheel 31 and a guiding wheel 32. Each side of the traction cart 30 is provided with four traveling wheels 31 and two guiding wheels 32, meaning that the traction cart 30 has a total of eight traveling wheels 31 and four guiding wheels 32 to ensure that the traction cart 30 can run smoothly along the guiding rails 20.

The traveling wheels 31 on two sides of the traction cart 30 rollably abut against the top surfaces of the two guiding rails 20, respectively, meaning that the traveling wheels 31 are placed downward on the guiding rails 20, and the guiding rails 20 support the traveling wheels 31. The guiding wheels 32 on two sides of the traction cart 30 rollably abut against the top walls of the depressions 21 of the two guiding rails 20, respectively, such that the guiding wheels 32 are limited by the side walls of the depressions 21 in the lateral direction and the guiding wheels 32 are limited by the top walls of the depressions 21 in the vertical direction. The guiding wheels 32 can roll along the top walls of the depressions 21, effectively preventing lateral deviation of the traction cart 30 during operation and preventing vertical vibration of the traction cart 30.

The traction cart 30 is provided with a driving gear 33 and a driving mechanism for driving the driving gear 33 to rotate. The driving gear 33 meshes with the rack 10 and the driving gear 33 is rotatably mounted on the traction cart 30. When the driving gear 33 rotates, it can drive the traction cart 30 to move forward or backward along the rack 10. The driving gear 33 controls the forward and backward movement of the traction cart 30 by changing its rotation direction (forward or forward).

The material cart 90 is movably disposed on the two guiding rails 20 and the material cart 90 is located in front of the traction cart 30. The traction cart 30 is used to drive the material cart 90 to move forward or backward along the guiding rails 20. The traction cart 30 is provided with two hook pulling members, an electric push rod, and a mounting rod. The mounting rod is movably disposed at the front end of the traction cart 30, the two hook pulling members are fixedly disposed on the mounting rod, and a piston rod of the electric push rod is connected to the mounting rod. The electric push rod drives the mounting rod to move to drive the two hook pulling members to flip, and the rear end of the material cart 90 is fixedly provided with a crossbeam. The two hook pulling members can flip to hook onto or detach from the crossbeam. In this way, when the traction cart 30 needs to drive the material cart 90 forward, the two hook pulling members hook the crossbeam, and the traction cart 30 can push the material cart 90 forward. When the material cart 90 moves into place, the two hook pulling members detach from the crossbeam, and the traction cart 30 separates from the material cart 90. When the traction cart 30 needs to pull the material cart 90 back, the two hook pulling members hook the crossbeam, and the traction cart 30 can pull the material cart 90 back.

The guiding wheels 32 have the same mounting structure. For clearer description, only the mounting structure of a single guiding wheel 32 is described below.

The guiding wheels 32 are adjustably disposed on two sides of the traction cart 30, and the guiding wheels 32 can be adjusted in a vertical direction, such that the guiding wheels 32 approach or leave the top walls of the depressions 21. In this embodiment, mounting seats 34 are disposed on two sides of the traction cart 30, the mounting seat 34 is fixedly provided with a support portion 341, the mounting seat 34 is vertically provided with a guide hole 342, and a movable plate 35 is movably inserted into the guide hole 342, such that the movable plate 35 can move up and down relative to the mounting seat 34. The upper end of the movable plate 35 is fixedly provided with a connecting portion 351, and the connecting portion 351 is located above the support portion 341. The connecting portion 351 is provided with a threaded through hole 3511, a bolt 36 passes downward through and engages with the threaded through hole 3511, and the lower end of the bolt 36 abuts against the upper surface of the support portion 341. The upper surface of the support portion 341 is provided with a groove 3411, and the lower end of the bolt 36 abuts against the bottom surface of the groove 3411. The lower part of the movable plate 35 is fixedly provided with a mounting column 352, and the mounting column 352 is perpendicular to the movable plate 35. The mounting column 352 extends into the depression 21, and the guiding wheel 32 rotatably sleeves the mounting column 352. In this way, the guiding wheels 32 can be adjusted to fit different specifications of the guiding rails, further improving guiding performance. Additionally, the movable plate 35 can be adjusted vertically by simply turning the bolt 36, thus adjusting the position of the guiding wheels 32 in the vertical direction, which provides a simple structure and convenient operation. The lower end of the bolt 36 abuts against the bottom surface of the groove 3411, and the groove 3411 can limit the lower end of the bolt 36, preventing the bolt from tilting under force, thereby further improving the stability of the guiding wheels 32.

The driving mechanism includes a driving motor 40, a first transmission shaft 50, and a second transmission shaft 60. The driving motor 40 is fixedly disposed on the upper side of the traction cart 30, and the first transmission shaft 50 is rotatably disposed on the upper side of the traction cart 30. Specifically, the traction cart 30 is provided with two first bearing seats, and the first transmission shaft 50 is rotatably mounted on the two first bearing seats. A first transmission gear 51 fixedly sleeves the first transmission shaft 50. An output shaft of the driving motor 40 is coaxially connected to the first transmission shaft 50 through a reduction mechanism, and the driving motor 40 is configured to drive the first transmission shaft 50 to rotate. The second transmission shaft 60 is rotatably disposed on the lower side of the traction cart 30. Specifically, the traction cart 30 is provided with three second bearing seats, and the second transmission shaft 60 is rotatably mounted on the three second bearing seats. A second transmission gear 61 fixedly sleeves the second transmission shaft 60. The first transmission gear 51 and the second transmission gear 61 are connected via a chain 70 to synchronously rotate. The traction cart 30 is provided with a through hole 37 for the chain 70 to pass through, and the driving gear 33 fixedly sleeves the second transmission shaft 60. In this way, the driving motor 40 drives the first transmission gear 51 to rotate via the first transmission shaft 50, and the first transmission gear 51 drives the second transmission gear 61 to rotate synchronously via the chain 70, and finally drives the driving gear 33 to rotate via the second transmission shaft 60, thereby driving the material cart 30 to move forward or backward along the rack 10.

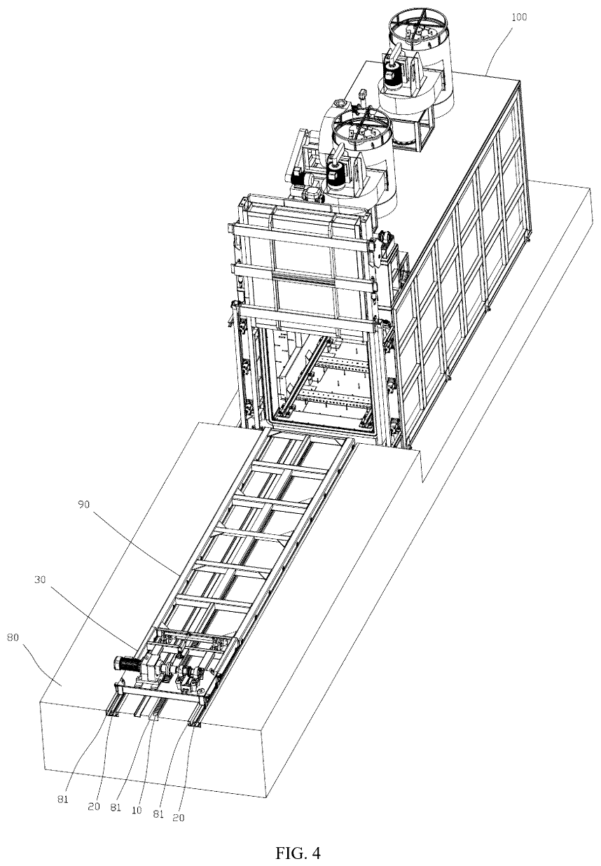

As shown in FIG. 4, the annealing furnace of this embodiment includes the feeding and discharging apparatus and the furnace body 100. When the product needs to be annealed, the product is placed on the material cart 90. The traction cart 30 hooks and pulls the material cart 90, and then the traction cart 30 pushes the material cart 90 forward, so as to push the material cart into the furnace body 100. Subsequently, the traction cart 30 and the material cart 90 are separated, the traction cart 30 retreats, and the material cart 90 is left inside the furnace body 100. The furnace door is then closed to anneal the product on the material cart 90. After the annealing is completed, the traction cart 30 advances. Next, the traction cart 30 hooks the material cart 90, and then the traction cart 30 pulls the material cart 90 out of the furnace body 100, thereby taking out the annealed product from the furnace body 100.

This specification and the accompanying drawings are merely exemplary illustrations of this application and are considered to cover any and all modifications, variations, combinations, or equivalents within the scope of this application. It is apparent that those skilled in the art can make various modifications and variations to this application without departing from the scope of this application. Thus, if these modifications and variations of this application fall within the scope of this application and its equivalent technologies, this application intends to include these modifications and variations.

What is claimed is:

1. A feeding and discharging apparatus, comprising a rack, two guiding rails, a traction cart, and a material cart, wherein
the rack extends linearly;
the two guiding rails are respectively located on two sides of the rack, the two guiding rails both extend linearly and are parallel to the rack, and side walls of the two guiding rails are each provided with a depression extending along a length direction of the guiding rail;
two sides of the traction cart are each provided with a traveling wheel and a guiding wheel, the traveling wheels on two sides of the traction cart rollably abut against top surfaces of the two guiding rails, respectively, and the guiding wheels on two sides of the traction cart rollably abut against top walls of the depressions of the two guiding rails, respectively;
the traction cart is provided with a driving gear and a driving mechanism for driving the driving gear to rotate, and the driving gear meshes with the rack, such that the driving gear rotates forward or backward to drive the traction cart to move forward or backward along the rack; and
the material cart is movably disposed on the two guiding rails, and the traction cart is configured to drive the material cart to move forward or backward along the guiding rails.

2. The feeding and discharging apparatus according to claim 1, wherein the guiding wheels are adjustably disposed on two sides of the traction cart, and the guiding wheels are adjustable in a vertical direction, such that the guiding wheels approach or leave the top walls of the depressions.

3. The feeding and discharging apparatus according to claim 2, wherein mounting seats are disposed on two sides of the traction cart, the mounting seat is fixedly provided with a support portion, the mounting seat is vertically provided with a guide hole, a movable plate is movably inserted into the guide hole, an upper end of the movable plate is fixedly provided with a connecting portion, and the connecting portion is located above the support portion, the connecting portion is provided with a threaded through hole, a bolt passes downward through and engages with the threaded through hole, a lower end of the bolt abuts against an upper surface of the support portion, and the guiding wheel is disposed on a lower portion of the movable plate.

4. The feeding and discharging apparatus according to claim 3, wherein the upper surface of the support portion is provided with a groove, and the lower end of the bolt abuts against a bottom surface of the groove.

5. The feeding and discharging apparatus according to claim 1, wherein the driving mechanism comprises a driving motor, a first transmission shaft, and a second transmission shaft, the driving motor is fixedly disposed on an upper side of the traction cart, the first transmission shaft is rotatably disposed on the upper side of the traction cart, a first transmission gear fixedly sleeves the first transmission shaft, the driving motor is configured to drive the first transmission shaft to rotate, the second transmission shaft is rotatably disposed on a lower side of the traction cart, a second transmission gear fixedly sleeves the second transmission shaft, the first transmission gear and the second transmission gear are connected via a chain to rotate synchronously, the traction cart is provided with a through hole for the chain to pass through, and the driving gear fixedly sleeves the second transmission shaft.

6. The feeding and discharging apparatus according to claim 1, wherein the rack and the two guiding rails are both embedded underground.

7. An annealing furnace, comprising the feeding and discharging apparatus according to claim 1.

8. An annealing furnace, comprising the feeding and discharging apparatus according to claim 2.
